(19) United States
(12) Patent Application Publication
(10) Pub. No.: US 2025/0371086 A1
(43) Pub. Date: Dec. 4, 2025

(54) SYSTEMS AND METHODS FOR SEARCH ALTERATION IN NON-LINEAR MEDIA

(71) Applicant: Adeia Guides Inc., San Jose, CA (US)

(72) Inventors: Aldis Sipolins, Somerville, MA (US); Ning Xu, Irvine, CA (US)

(21) Appl. No.: 18/680,031

(22) Filed: May 31, 2024

(51) Int. Cl. G06F 16/9535; A63F 13/47; A63F 13/77; G06F 16/9032

(52) U.S. Cl. CPC G06F 16/9535; A63F 13/47; A63F 13/77; G06F 16/90324

(57) ABSTRACT

Aspects of the present application help to alter searches in non-linear media. In some embodiments, a server may receive a part of a user search query related to non-linear content. The server may access progress data that is associated with the user profile and perform a search on a database using the progress data and the search query to produce a number of candidate content items (e.g., search results). The server may access a data structure that defines possible paths through the non-linear media, and may filter the candidate content items based on the progress data and the data structure that defines the possible paths through the non-linear media to generate output of a filtered candidate content item.

### BACKGROUND

This disclosure is related to computerized search data processing and search systems and methods, and in particular to processing data sources related to non-linear media in a way that helps to prevent transmission and communication of spoilers associated with the non-linear media.

### SUMMARY

In some implementations, media (e.g., movies, television series, “traditional” videogames) provide linear experiences, with all users of such media consuming the media via the same path (e.g., from start to finish). In certain types of interactive media, such as “modern” videogames, an interactive media system offers user interfaces for following a non-linear game structure through open-world design and/or branching storylines (e.g., interactive media that is navigable similar to a “choose your own adventure” narrative). In a non-linear interactive media, two users consuming the same media might not complete the same quests, meet the same characters, or travel to the same locations.

Computerized search system (e.g., standalone search engines or search functions built into another application) allow for processing of user interfaces searches for solutions using Internet-based databases or other electronic data storage mediums (e.g., social media databases) for navigating interactive media. For example, a search system can process a user interface query that requests assistance in overcoming adversity in navigating or completing the interactive media (e.g., a video game). However, there exists a risk that the results of the search may spoil later levels or other content of the videogame, e.g., by providing information that was meant to be discovered naturally by exploration of or engagement with the interactive media. Consequently, such search systems will waste computational and network resources by extracting and providing information that is not relevant to the query. Worse, such “spoilers” in the search results may deteriorate expected interactions with the information and may discourage future use of the search system, and/or with the media itself.

In some approaches, in linear media, a system may be configured to implement spoiler prevention by determining, for example, the current level the user is playing, and preventing information related to future levels from being displayed. However, in non-linear videogames, the unpredictability of user interface interactions with the interactive concern (e.g., a video game), a desired feature of non-linear games, makes it more challenging for systems to implement spoiler prevention as predictive search features are inaccurate, and the corresponding results may potentially spoil content for user searching for tips online. For example, traditional search engines and community forums (e.g., Reddit™) offer a wealth of information but often inadvertently spoil videogame content due to a lack of context about the tracked user's progress and choices within the videogame and overall structure of the video game. The need for searching for content related to the non-linear content is even more pervasive in non-linear media due to the multitude of possible paths to traverse the media.

To help address these problems, systems and methods are provided herein for spoiler prevention in non-linear media. For example, a server may facilitate a gaming session for a user playing a non-linear videogame that includes a castle level, forest level, and swamp level. In some embodiments, a server may receive a part of a user search query related to non-linear content. For example, the server may receive a search query “how do I find . . . ?” which generate a few autocomplete suggestions including “how do I find a slime potion?” The server may then access progress data that is associated with the user profile and performs a search on a database using the progress data and the search query producing a plurality of candidate content items (e.g., search results). For example, the server retrieves progress data that indicated the user's avatar is playing within the swamp level and has not traversed the forest level and performs the search that results in tips for finding the slime potion and finding forest items. The server may then access a data structure that defines possible paths through the non-linear media (e.g., accesses the game metadata that has the level structures for all possible levels including castle, forest and swamp levels). The server may then filter the candidate content items based on the progress data and the data structure that defines the possible paths through the non-linear media to generate output of a filtered candidate content item. Continuing with such examples, although the server produced tips (e.g., candidate content items) for both finding the slime potion and finding the forest item, the server filters the slime potion as this is both relevant to the search query “how do I find the slime potion?” and it is relevant to the progress data where the user is currently playing the swamp level.

In some embodiments, the server filters the candidate content items by determining a user profile progression level. In some approaches, the profile progression level is based on correlating the progress data with the levels within the videogame. The server may then exclude the candidate content items that are associated with the levels of the game that were not traversed (based on the correlation). For example, the server may determine the progression level based on the user having traversed the swamp level and not yet the forest level. In such examples, the server will exclude candidate content items that are associated with the forest level.

In yet other embodiments, the server filters the candidate content items by determining a user profile progression level and excluding the candidate content items that are associated with the levels of the game that are not proximate to the user profile progression level. To determine the proximity, the server may determine a particular candidate content item includes a game reference (e.g., “swamp wand”) and determines an association with the game level (e.g., swamp level). The server may then identify an in-game path between the user's progression and the level, and (for proximity) determines if distance is within a threshold. For example, the server may determine that the user having the swamp wand is within the accepted proximity of the swamp level (e.g., no more than 1 level away or 2 levels away).

In some embodiments, the server filters the candidate content items by identifying a path taken by a game character through various levels. The server may then exclude candidate content items associated with levels of the videogame determined not to be proximate to the path taken by the game character.

In some embodiments, the server may access a data structure that defines a number of possible paths through the non-linear media by transmitting a request to a gaming client (or streaming server, social media application, etc.) for game structure data. In some embodiments, the server may access the data structure by transmitting a request to a gaming client (or streaming server, social media application, etc.) for multiple progress data for multiple users. Upon receiving this data, the server may generate based on this received data a number of paths through connected levels of the game.

In some embodiments, the server of a search system performs layers of large language model (LLM) analysis, where a first layer of analysis may include inputting the query and data relevant to the game into the LLM to produce candidate search results. A second layer of analysis may include inputting the candidate search results, the progress data, and date defining non-linear game structure into an LLM to achieve appropriate filtering or modification of candidate search results to prevent spoilers.

The various disclosed systems and methods, as described above and within this disclosure, improved functionality of a search system by prevents generation, transmission and display of search results that contain spoilers for non-linear media. In this way the system provides a user interface that may be used effectively search for content related to the non-linear content without incurring returned results that unduly spoil the interactive media experience.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1A shows an illustrative scenario in a server is performing a search related to a gaming application, in accordance with some embodiments of this disclosure.

FIG. 1B shows an illustrative scenario in which a server is filtering candidate content items based on a user profile's level in a non-linear structure, in accordance with some embodiments of this disclosure.

FIG. 1C shows an illustrative scenario in which a game structure for a non-linear media is shown, in accordance with some embodiments of this disclosure.

FIG. 2 shows an illustrative scenario of a linear gaming application structure, in accordance with some embodiments of this disclosure.

FIG. 3 shows an illustrative scenario of a non-linear gaming application structure, in accordance with some embodiments of this disclosure.

FIG. 4 shows an illustrative scenario of paths taken in an open-world non-linear gaming application, in accordance with some embodiments of this disclosure.

FIG. 5 shows an illustrative scenario of a displayed user interface of progress data for a non-linear gaming application, in accordance with some embodiments of this disclosure.

FIG. 6 shows an illustrative scenario of a displayed user interface of a gaming client displaying progress data for a non-linear gaming application, in accordance with some embodiments of this disclosure.

FIG. 7 shows illustrative user equipment devices, in accordance with some embodiments of this disclosure.

FIG. 8 shows illustrative systems, in accordance with some embodiments of this disclosure.

FIG. 9 is a flowchart of a detailed illustrative process for filtering candidate content items to generate for output at least one candidate content item of the filtered plurality set of candidate content items, in accordance with some embodiments of this disclosure.

FIG. 10 is a flowchart of a detailed illustrative process for excluding a candidate content item from the filtered plurality of candidate content items, in accordance with some embodiments of this disclosure.

FIG. 11 is a flowchart of a detailed illustrative process for generating a plurality of paths through connected levels of a gaming application, in accordance with some embodiments of this disclosure.

FIG. 12 is a flowchart of a detailed illustrative high-level process of the disclosed system, in accordance with some embodiments of this disclosure.

### DETAILED DESCRIPTION

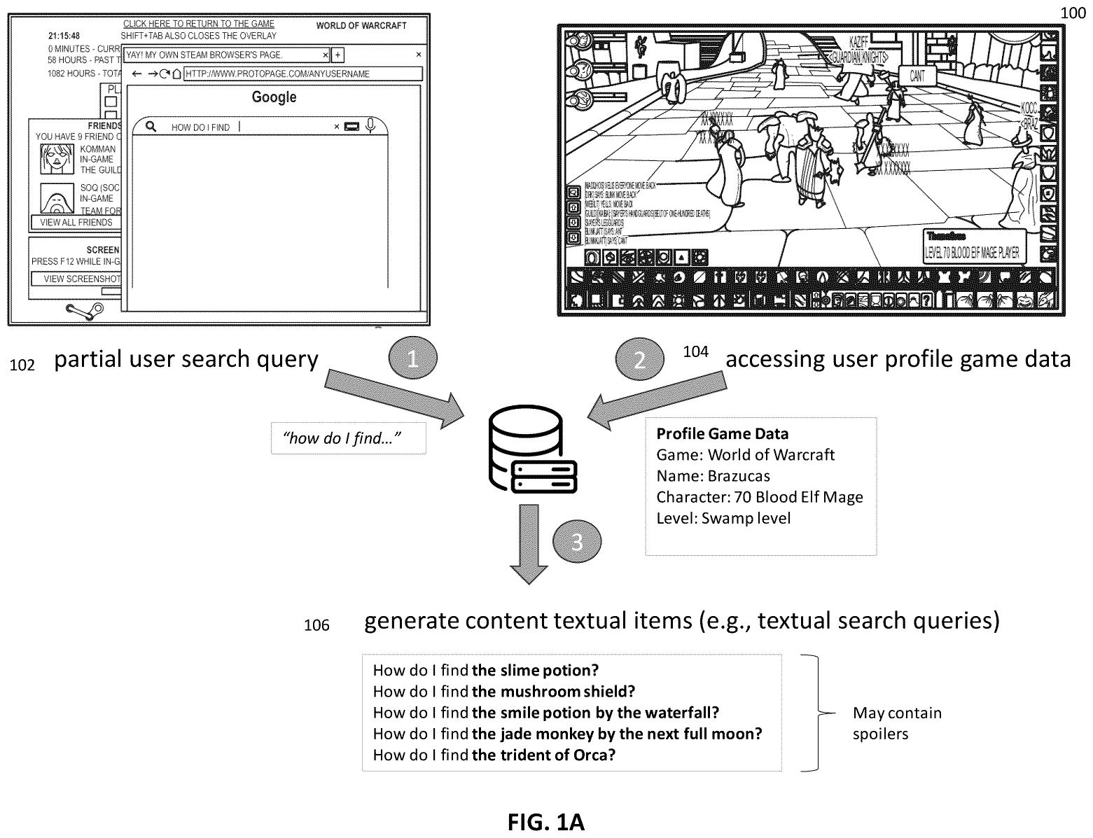

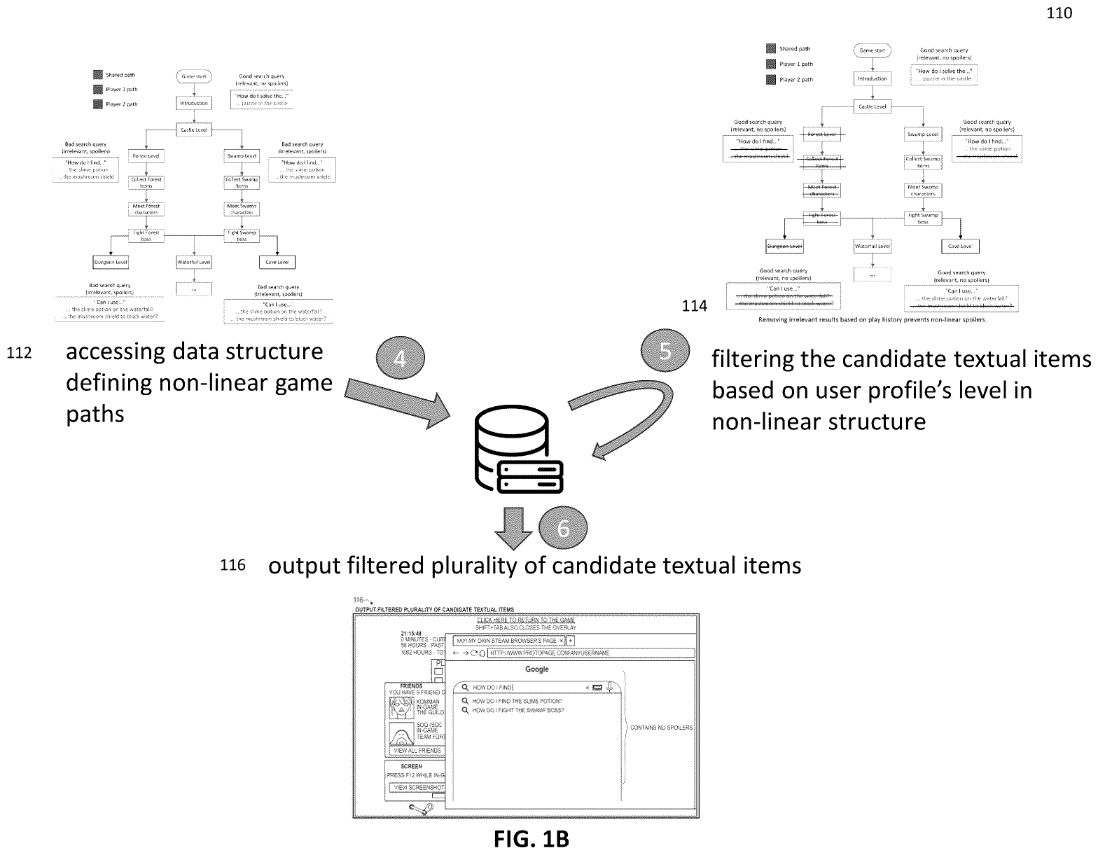

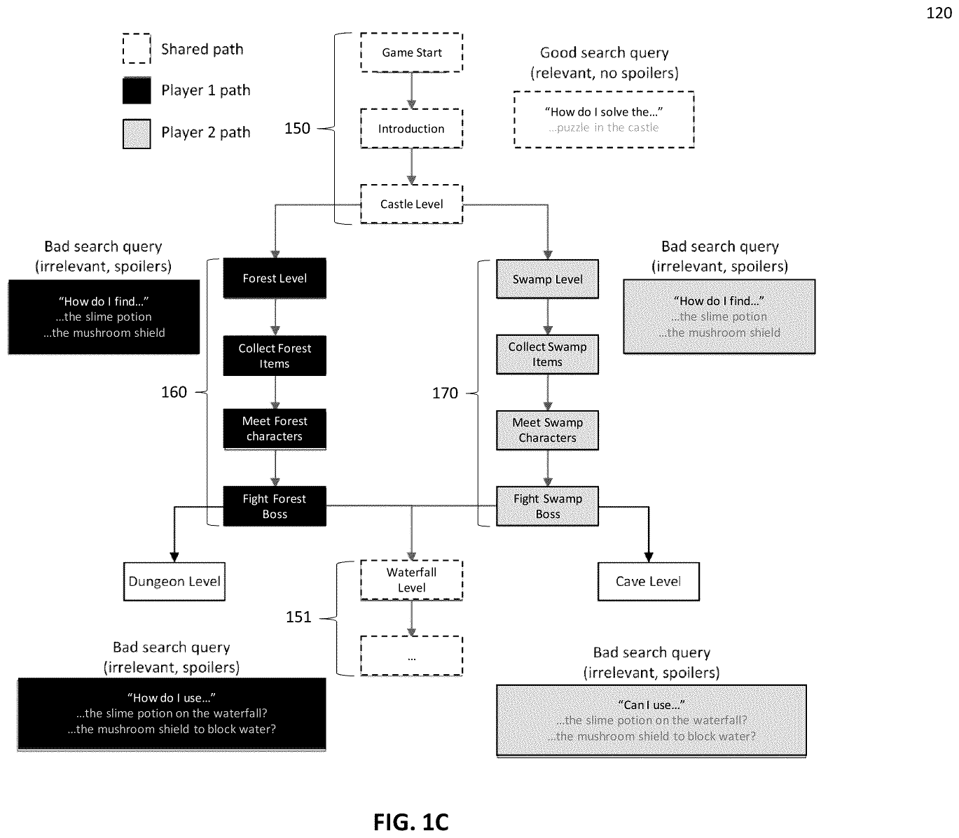

FIG. 1A shows an illustrative scenario 100 in which a server is performing a search related to a gaming application, in accordance with some embodiments of this disclosure. In some embodiments, a server is implemented to process and execute spoiler prevention for non-linear media. In some embodiments, the server may execute a search application to implement spoiler prevention for non-linear media. In some embodiments, the server may execute a media application to implement spoiler prevent to non-linear media. In some embodiments, non-linear media content includes a gaming application. The server receives from a device associated with a user profile, at least a part of a user search query. The user search query may relate to non-linear media content (e.g., an open-world game). In FIG. 1A, the server receives a partial user search query 102 from a gaming client having a browser application open that search for “how do I find . . . ”. This may be typical of players who wish to search for tips for the gaming application online to aid them in completing the game.

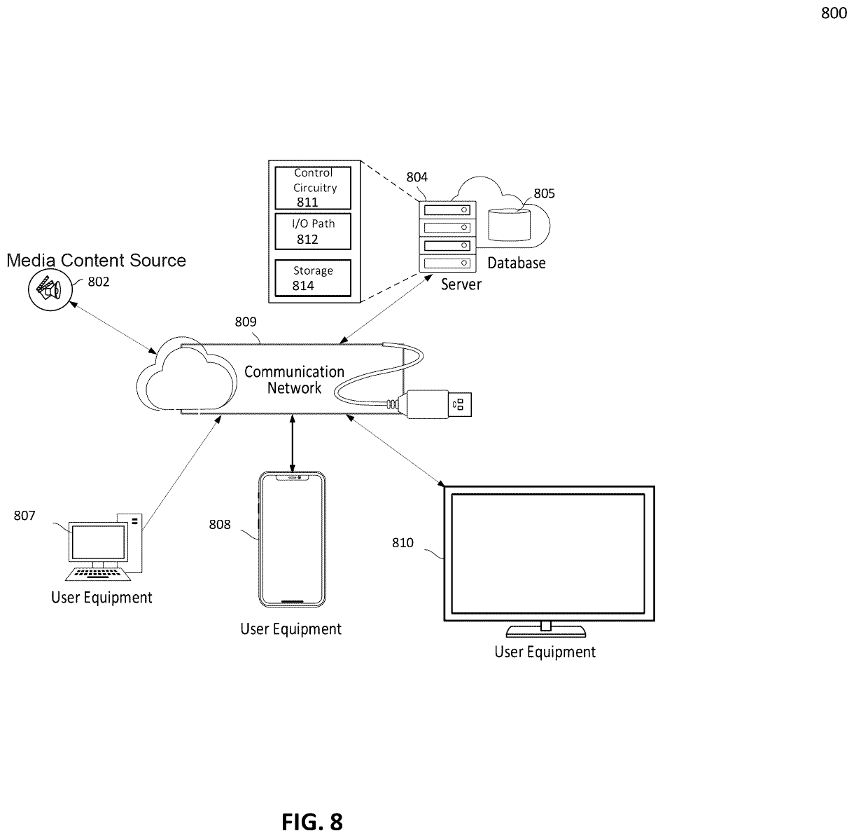

The device associated with the user profile (e.g., one of devices 807, 808, or 810 of FIG. 8) may be any user equipment that facilitates a gaming application (e.g., hardware with processor, display, and I/O components such as a personal computer, gaming system, mobile phone, AR/VR enabled hardware, etc.). In some embodiments, the search query may be received by the server via the gaming client. For example, the gaming client may have a messaging platform (e.g., instant messaging between players, or game-chat, or streaming chat, or forums, or similar communication mediums) from which the server receives a search query. The server may receive the search query by monitoring the character input of the user associated with the user device for the gaming application. In some embodiments, the search query may be received via determination of text input in a messaging platform (e.g., gaming client). In some embodiments, the search query may be received via a speech-to-text methodology that receives text from monitoring gaming audio chats (e.g., Discord™ or in-game audio chat).

In some embodiments, at least a part of a user search query may include a partial text input (e.g., being received from a game client). In some embodiments, at least a part of a user search query may include a partial audio input (e.g., the start of a conversation converted from speech to text). In some embodiments, at least a part of a user search query may include a partial image input (e.g., using an image to find similar images, or using a picture of a location to find coordinates of the location within the game). In some embodiments, at least a part of a user search query may include a partial video input (e.g., using a video to identify one or more objects within the video being present within the game).

In some embodiments, the server may access progress data that identifies progression through the non-linear media content associated with the user profile. Following FIG. 1A, the server accesses at 104 a user profile game data from the gaming client (e.g., Steam™). The progress data includes the game title (e.g., World of Warcraft), the name of the character (e.g., Brazucas), the character level (e.g., 70 Blood Elf Mage), and game level (e.g., Swamp level). In some embodiments, a level may be a linear level within a linear game. In some embodiments, a level may be a region within an open world non-linear game. In some embodiments, the server may perform a search using at least one database that stores data relevant to the non-linear media content to generate a plurality of candidate content items. Candidate content items may be any type of content item including textual, audio, image, video, XR, or other medium of content. The search may use the progress data associated with the user profile and the at least the part of the user search query. Returning the FIG. 1A, the server performs the search at 106 “how do I find . . . ” and generates a number of candidate specific textual items including:
How do I find the slime potion?
How do I find the mushroom shield?
How do I find the smile potion by the waterfall?
How do I find the jade monkey by the next full moon?
How do I find the trident of Orca?
   Such a search may be performed, for example, using an LLM into which data from steps 102 and 104 is inputted. The above referenced specific textual items may contain spoilers. For example, if the player has not yet ventured to the waterfall level, the referenced textual item “How do I find the smile potion by the waterfall” may spoil that a smile potion exists, and it is in relation to the waterfall level. In some embodiments, the server may generate for output one or more autocomplete suggestions based on the received part of the user search query. The server may then receive a selection of one of the one or more autocomplete suggestions from the device associated with the user profile. Using the above example, the server may receive the part of the user search query “how do I find . . . ” and the server may autocomplete to “How do I find the slime potion?” and “How do I find the mushroom shield?” The server may receive a selection from the user of the autocomplete suggestion “How do I find the slime potion?”

In some embodiments, if the candidate content item is an audio item, the serve may alter the audio output of that particular audio candidate content item. For example, the server may prevent the audio from being played or alter the sound level to 0 dB to prevent any spoiler from being perpetuated from the particular audio candidate content item. In other examples, the server may distort the audio to prevent any spoiler from being perpetuated from the particular audio candidate content item. In some embodiments, if the candidate content item is an image item, the server may alter the image output of that particular candidate content item. For example, the server may generate for display a distorted version of the image (e.g., blurred image) such that the content of the image cannot be deciphered. In other examples, the server may remove the entire image output such that is it not even an option to select. Similar techniques may be implemented for video and XR candidate content items.

In some embodiments, the server may access progress data from a gaming client whereby the gaming client may provide the level of progress that may include: data indicating level completion, data indicating in-game items that were collected, data indicating in-game opponents that were defeated, data indicating which achievements were completed, data indicating which quests were completed, data indicating position within a scoreboard, data indicating amount of time spent within the gaming application, data indicating win-loss ratio, data indicating kill-death ratio, data showing location of character presently and over time, data indicating experience points gained, data indicating skills chosen, data indicating which in-game characters were encountered, or the like.

In some embodiments, the server may access a data structure that defines a plurality of possible paths through the non-linear media content. In some embodiments, the plurality of possible paths includes a plurality of paths through connected levels of a gaming application. FIG. 1B shows an illustrative scenario 110 in which a server is filtering candidate content items based on a user profile's level in a non-linear structure, in accordance with some embodiments of this disclosure. In this example, the server accesses a game data structure 112 which has a plurality of paths including a castle level that leads to either a forest level or alternatively a swamp level. From either the forest level or swamp level, the subsequent levels may differ, with the only mutual next possible level being the waterfall level. The data structure that defines the plurality of paths may be stored in a variety of format including unformatted data, formatted data such as a table/database (e.g., at shown in paragraph 0050), or other electronic format that is accessible by the server to calculate, process, or recall the game structure. In some embodiments, connected levels may include levels that are not physically adjacent, but rather connected by other means (e.g., similar theme, similar regions, or other similarities between segments of a non-linear game).

FIG. 1C shows an illustrative scenario 120 in which a game structure for a non-linear media is shown, in accordance with some embodiments of this disclosure. Multiple paths are shown for example the path 150 includes the game start, introduction, and castle level. Path 160 includes the forest level, collect forest items, meet forest characters, and fight forest boss. Path 170 includes the swamp level, collect swamp items, meet swamp characters, and fight swamp boss. Path 151 includes the waterfall level. Multiple paths may be taken by different players, and they can still get to the same eventual level. For example, a player may take path 150 and 160 and eventually reach the waterfall level. In another example, a player may take path 150 and 170, and then reach the waterfall level.

In some variants, as can be seen from the non-linear media gaming structure, Player 1 may pursue a portion of gaming path 170 that starts from castle level and pursues the swamp level and then ventures to the cave level. A different player (e.g., Player 2) may pursue a portion gaming path 160 that starts from castle level and pursues the forest level and then ventures to the dungeon level. Player 1 and Player 2 may have also shared path 150-151 (e.g., game start-introduction-castle, and onwards from the waterfall). In some approaches, Player 1's path is combination of paths 150, 170, and 151, while Player 2's path is combination of paths 150, 160, and 151. After the castle level, the game being non-linear, allows for each of the players to pursue different paths through the gaming structure. In some embodiments, the server may access the data structure 120 via a gaming client. In some embodiments, the server may access the data structure via a database related to the non-linear media. In some embodiments, the server may access the data structure via a device associated with the user accessing the non-linear media. In some embodiments, the server may store current location of each of the players, the past paths of both of the players in one or more data structures that leverage the data structure 120. For example, a path of the first player may comprise data structure 120 and data tracking the order in which levels of data structure 120 were visited. For example, data structure 120 may be stored as graph data, where every vertex is a level and connections are edges. In this example, the path of the first player may be stored as an ordered list of vertices of data structure 120.

In the example of FIG. 1C, since the first three levels (game start, introduction and castle levels) of structure 120 are linear, the server may complete a search query “how do I solve . . . ” with “a puzzle in the castle level” which would be an appropriate result for both Players 1 and 2. After the paths of Players 1 and 2 split, the search system of the server may be at risk of producing undesirable results. For example, completing the query “how do I find . . . ” with “the slime potion” or “mushroom shield” may be an inappropriate or undesirable spoiler for Player 1 since the slime potion is not available in the forest path. Similarly, completing the query “how do I find . . . ” with “the slime potion” or “mushroom shield” may be an inappropriate spoiler for Player 2 since the mushroom shield may not be available in the swamp path. Techniques described herein provide techniques for avoiding the server producing such undesirable results.

In some embodiments, the server may filter 114 the plurality of candidate content items to generate a filtered set of candidate content items, wherein the filtering 114 is based on: (a) the progress data associated with the user profile, and (b) the data structure that defines the plurality of possible paths through the non-linear media content. For example, the filtering 114 may be performed by inputting a data structure defining the paths in the game and progress data into an LLM trained to identify and/or remove spoilers. Returning to FIG. 1B, the server filters 114 the plurality of candidate content items (e.g., the possible search query results) based on the progress data such as the player being a level 70 Blood Elf Mage in the Swamp Level. The server also filters the plurality of candidate content items based on the game structure 120 such as the forest level and dungeon level not being traversed, and moreover the swamp level has been traversed. Thus, following this example, the filtered candidate content items will only include those related to the swamp level. In some embodiment, filtering 114 may utilize a supplemental data structure that tracks locations of items, quest, and other game objects in respective levels. An example of such structure is shown below as Table 1.

In some embodiments, the server may generate for output at least one candidate content item of the filtered set of candidate content items. Returning to FIG. 1B, the server filters at 116 to output the filtered set of candidate content items that include “How do I find the slime potion?,” and “How do I fight the swamp boss?” There are no spoilers for other levels that have not yet been traversed such as candidate content items that relate to the dungeon level (e.g., how do I find the mushroom shield?). In some embodiments, the generation for output is provided through the same user interface from which the at least the part of the user search query was received. In some embodiments, the generation for output is provided through a separate user interface from which the at least the part of the user search query was received.

In some embodiments, the generated output may be customized based on a number of factors. The server may present the user with a summary including only essential advice, strategies, or information derived from the filtered search results, tailored to the player's query and context. The summary aims to provide immediate, actionable insights that the player can utilize without delving into detailed results. In some embodiments, the server implements an LLM to enhance the at least one candidate content item of the filtered set of candidate content items to present in a more concise manner. In some embodiments, the server may generate for output a detailed summary that includes the sources used to determine the results. In some embodiments, the server may generate for output a detailed summary with the results organized by relevancy. In some embodiments, the server may receive further query to the generated output from the user where the user may desire to access the original source for the information provided for further explanation. In some embodiments, the generated output may be integrated within the user interface of the gaming application. For example, the generated output may be integrated into a game chat, game messaging client, read via voice in-game, or similar or other format.

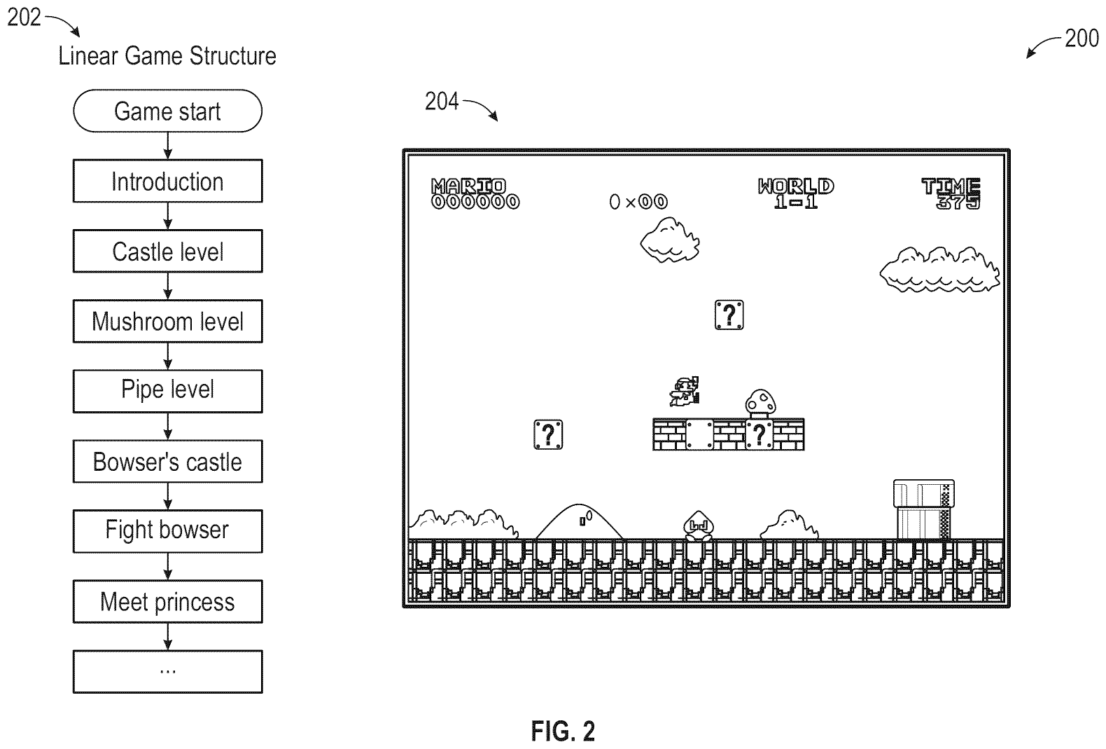

FIG. 2 shows an illustrative scenario 200 of a linear gaming application structure, in accordance with some embodiments of this disclosure. In this gaming structure, there exists the commencement of the game that sequentially leads to the introduction, castle level, mushroom level, pipe level, and then to Bowser's castle. Subsequent to the levels, the character fights Bowser, and finally meets Princess for the completion of the gaming structure. This is a linear game structure as there is no other route to completion of the game but for the sequential levels and achievements outlined previously. These games are typically organized by levels and achievements within the levels in order to complete the level. Once all the levels are completed by the character, the game is complete.

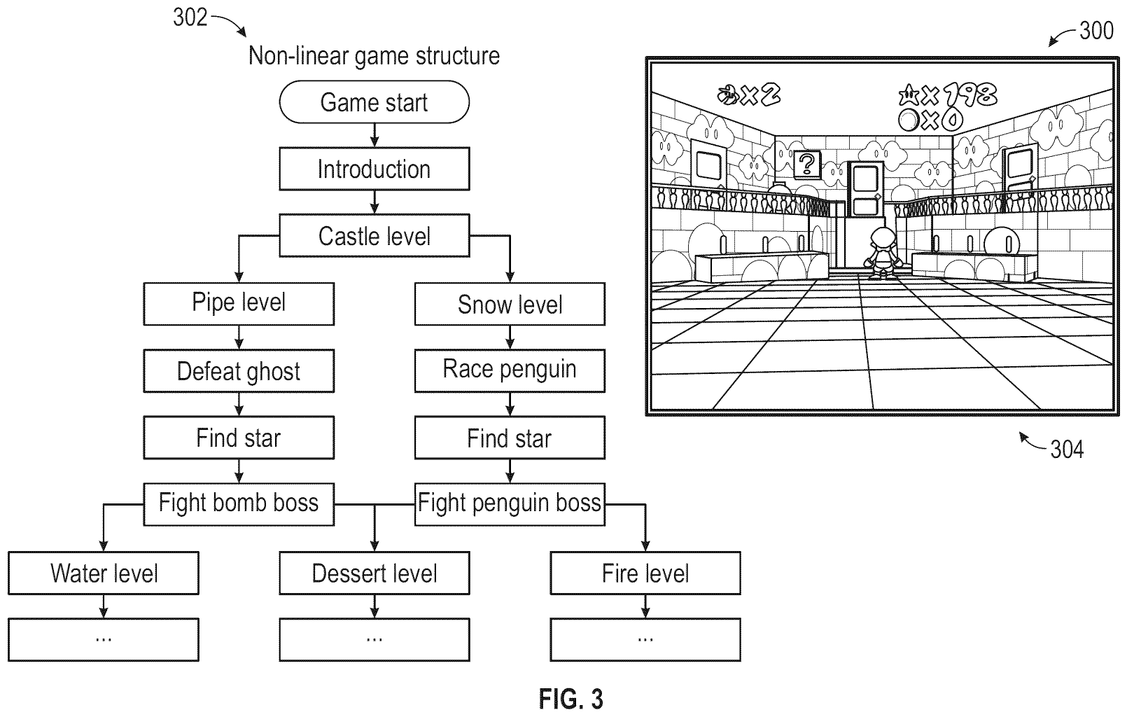

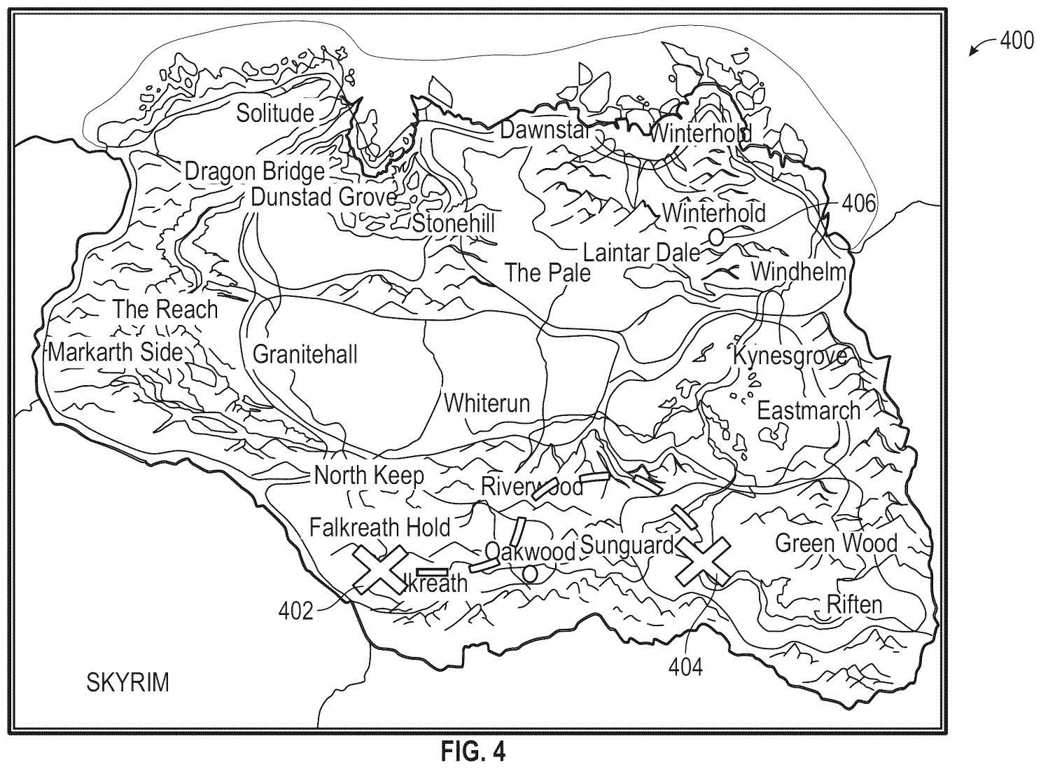

FIG. 3 shows an illustrative scenario 300 of a non-linear gaming application structure, in accordance with some embodiments of this disclosure. In contrast to FIG. 2 showing a linear gaming structure, FIG. 3 illustrates a non-linear gaming structure where the character starts the game, subsequently engages in the introduction and the castle level. At the castle level, the player has two options to either pursue the snow level or alternatively pursue the pipe level. Depending on the route taken (e.g., by navigating an avatar into different doors as shown in user interface 304), the path taken through the structure of the game will be altered. This is further differentiated at further decision points (e.g., fighting the bomb boss or fighting the penguin boss) where further alternative routes are presented. This non-linear gaming structure provides for different paths through the structure to achieve completion of the game. As a further example, FIG. 4 shows an illustrative scenario 400 of paths taken in an open-world non-linear gaming application, in accordance with some embodiments of this disclosure. FIG. 4 includes a map view of paths taken within an open-world game. A player takes path from 402, at the Falkreath Hold, to 404, the Rift. In other scenarios, the player may instead venture to Winterhold at 406.

In some embodiments, the server may filter the plurality of candidate content items by determining a user profile progression level. The user profile progression level may be based on the server correlating the progress data with a plurality of levels within the gaming application based on the plurality of possible paths. For example, a player of a game may have completed the swamp level but not the forest level. In another example, a player of a game may have travelled to the Rift but not Winterhold as shown in FIG. 4. The server may further filter the set of the plurality of candidate content items based on the user profile progression level by excluding one or more candidate content items associated with one or more levels or locations of the gaming application determined to be not traversed based on the correlating. Returning to FIG. 4, the server may filter the candidate content items based on a distance threshold from a player's current location. If the player is currently located at Rift and is far (greater than the distance threshold) from Winterhold and moreover, has not traversed Winterhold, then the server may filter to exclude the candidate content items related to Winterhold. If a conch shell item is attainable within the Winterhold region (e.g., as indicated by level structure), then the server would prevent the candidate content item “How can I find the conch shell?” from displaying and spoiling a quest that is not yet known to the player.

In some embodiments, continuing from the example above where the server filters the plurality of candidate content items by determining a user profile progression level, the user profile progression level may be based on the server correlating the progress data with a plurality of levels within the gaming application based on the plurality of possible paths. For example, a player of a game may have completed the swamp level but not the forest level. The server may then determine a subset of candidate content items based on the user profile progression level by excluding candidate content items associated with levels of the gaming application determined not to be proximate to the user profile progression level.

To determine proximity, the server may determine that a particular candidate content item of the candidate content items comprises a game reference. For example, a candidate content item may be “how do I find the slime potion?” In this example, the slime potion is a game reference. The server may then determine that the game reference is associated with a particular level of the plurality of levels within the gaming application. Continuing with this example, the server may determine that the slime potion relates to the slime level based on the game structure and analyzing other forms of game metadata. The server may then identify an in-game path between the user profile progression level and the particular level. Continuing with this example, the player is currently in the swamp level and the path to the slime potion is within the vicinity of the swamp level.

In some examples the path length may be measured in “level transitions.” For example, referring to FIG. 1C, the path between “Swamp Boss” in path 170 and “Waterfall” in path 151 may be counted as “one level transition,” while path between castle level in path 150 and “Fight Swamp boss” in path 170 may be “four level transitions.” A threshold distance for filtering results may be looser or tighter. For example, all data related to levels more than “1 level transition,” may be filtered or omitted by the server. In another example, all data related to levels more than “2 level transitions” may be filtered or omitted.

In some other examples, the distance between the current position of the player in the swamp level and the slime potion within the swamp level is one in-game mile (e.g., less than five minute walking pace for an avatar within the gaming application). The server may then determine whether a length of the in-game path between the user profile progression level and the particular level is smaller than a threshold length. In this example, the threshold may be two in-game miles. Thus, if the item “slime potion” appears in a level that is in locations separated by a distance from the user's avatar locations by path that is smaller than the threshold the server will not filter out this candidate content item and may generated information about the “slime portion” for output for the player. In another example, if the item “mushroom shield” appears in a level that is in locations separated by a distance from the user's avatar locations by path that is larger than the threshold the server will filter out this candidate content item and will not generate information about the “slime portion” for output for the player.

In some embodiments, the threshold is preconfigured by the gaming application. In some embodiments, the threshold may be configurable by the device associated with a user profile. In some embodiments, the threshold may be dynamic based on a plurality of players that engage with the gaming application. In some embodiments, a LLM may be used to determine proximity. The LLM may be trained on aggregate progress data related to the specific gaming application about which spoilers were considered acceptable and which spoilers were considered unacceptable. For example, a search result may be considered unacceptable if a certain ratio of users flagged the search results as poor or have avoided using the search engine after a display of a spoiler.

In some embodiments, the structure of paths through the game may be accessible to the server described in FIG. 1 (e.g., the data structure 120 may be provided by the game designed). In some embodiments, the data structure may be inherently available to an in-game search engine. In other embodiments, the server may use one or more of the techniques described below to generate the structure of the game from publicly available data.

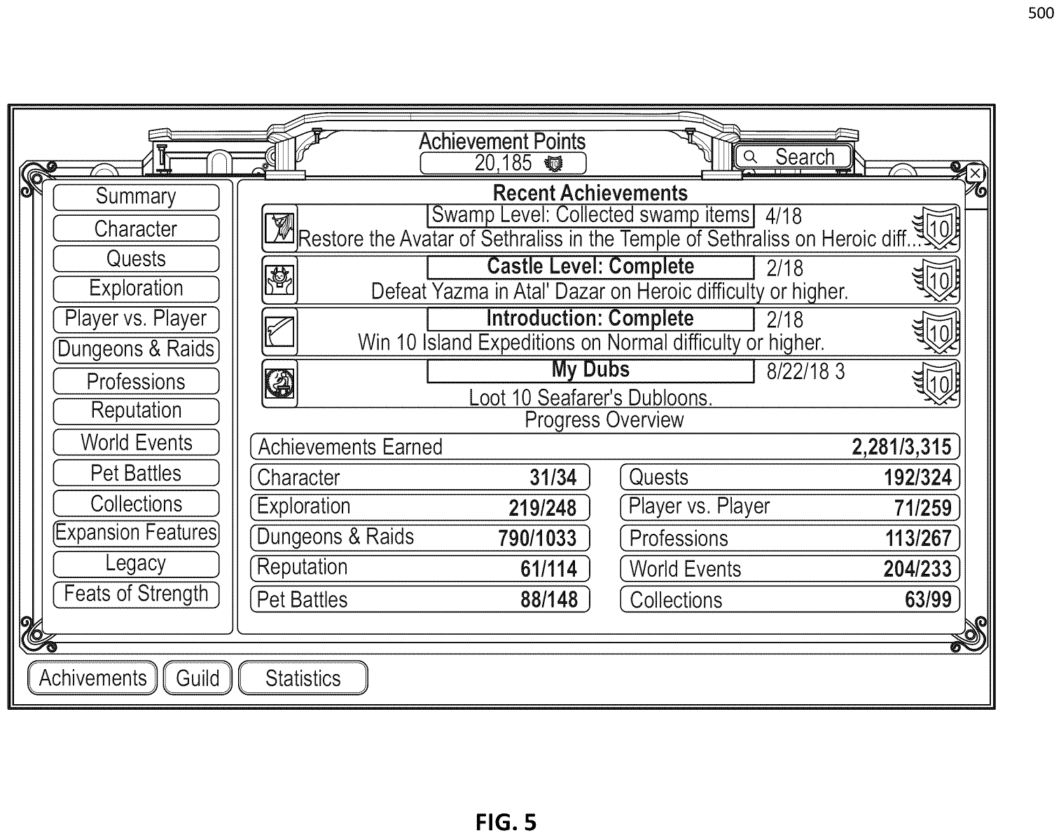

FIG. 5 shows an illustrative scenario 500 of a displayed user interface of progress data for a non-linear gaming application, in accordance with some embodiments of this disclosure. In this example, the generated display shows a player collecting swamp items within the swamp level. It also shows that the player has completed the castle level and the introduction previously. The server may access this type of progress data from the gaming application. In another example, the server may access this type of progress data from the gaming client. In some embodiments, the server may filter the plurality of candidate content items by

identifying a path through a particular plurality of levels taken by a game character associated with the user profile through the connected levels of the gaming application. For example, returning to FIG. 4, the player has traversed from Falkreath Hold to Rift along the dotted white line. The server may determine that the player did not encounter a quest to attain a conch shell. In some embodiments, the server may also incorporate a plurality of user profiles for the same gaming application to determine if other players, taking the same path from Falkreath Hold to Rift have encountered a quest to attain a conch shell. The server determines that none of the players traversing the Falkreath Hold to Rift have encountered a quest to attain a conch shell, and thus can create a gaming structure to remove the conch shell from this path within the game map. With the generated structure, the server may now determine a subset of candidate content items by excluding candidate content items associated with levels of the gaming application determined not to be proximate to the particular plurality of levels included in the path taken by the game character associated with the user profile. For example, if a player is traversing the Falkreath Hold to Rift and a possible textual candidate item reads “how do I find the conch shell?,” the server will exclude this textual candidate as the determined generated game structure does not provide for the conch shell to be found along the path traversed.

In some embodiments, the server may generate a supplemental data structure based on the data received and generated from the plurality of user profiles. For example, the server may create a supplemental data structure as shown below:

TABLE 1

| Character | Level | Items | Events |
|---|---|---|---|
| Elf Mage (60) | Castle, Swamp | Slime potion | Defeated swamp troll |
| Sorcerer (45) | Castle, Forest | wood flute | Completed tavern |
| Orc (83) | Castle, Swamp, | Slime potion, | Defeated swamp |
| | Waterfall | and gold coin | troll, dove into |
| | | | waterfall |

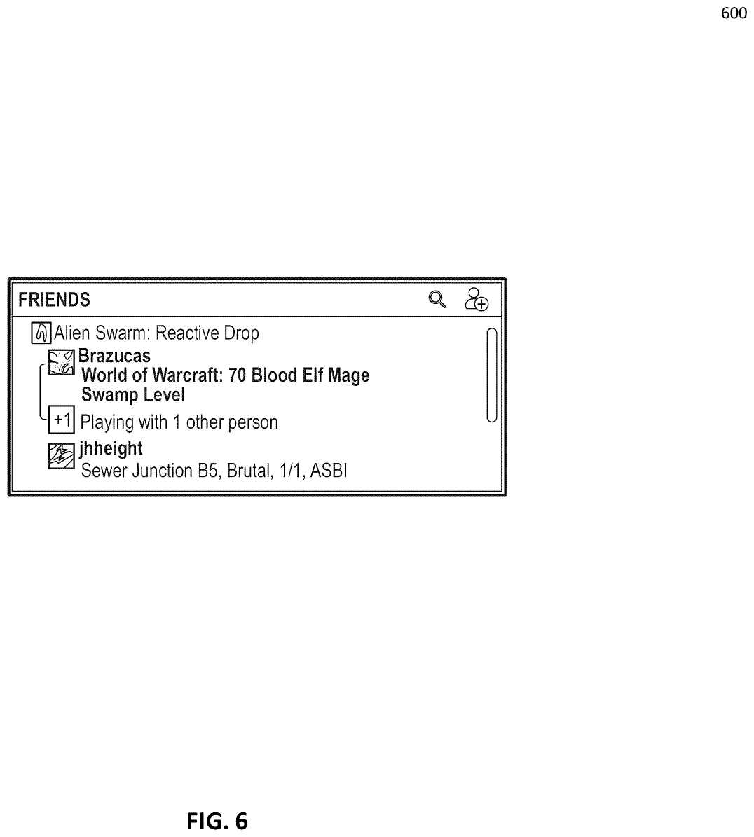

In some embodiments, the server may access the data structure by transmitting a request to a gaming client for the game structure data related to the gaming application. The game structure data defines at least a set of the plurality of paths through the connected levels of the gaming application. FIG. 6 shows an illustrative scenario 600 of a displayed user interface of a gaming client displaying progress data for a non-linear gaming application, in accordance with some embodiments of this disclosure. In this example, the gaming client displays that a player Brazucas, who is a level 70 Blood Elf Mage, is currently playing in the Swamp Level in the gaming application of World of Warcraft™. In some embodiments, the server may access the data structure by transmitting a request to a gaming client for a plurality of progress data of a plurality of user profiles. The server may then receive the plurality of progress data of the plurality of user profiles from the gaming client and generate the plurality of paths through the connected levels of the gaming application based on the received plurality of progress data of the plurality of user profiles from the gaming client. For example, the server may access thousands of gaming profiles from the gaming client that have thousands of progressions through an open world providing all different types of character builds, paths, items collected, bosses defeated, quests, sub-quests, side-quests, minigames, cutscenes, stages, and other achievements. Returning to FIG. 1C, in one example, the server may collect achievement from any number (e.g., 1000) profiles and analyze the data to create structure 120. For example, the sever may determine that 750 profiles indicated an achievement of reaching the waterfall level, but that only 300 of 750 profiles show an achievement for completing the forest level, and that only 350 of 750 profiles show an achievement for the swamp boss. This may lead to a determination that the waterfall levels are not prerequisite to reach the forest. It is likely that the forest is reachable by alternative paths through the forest and the swamp respectively. In some examples, a machine learning model may be used to create game path structure based on achievement data. In some embodiments, supplemental data structure such as shown in Table 1 may be compiled based on analysis of achievement profiles.

In some embodiments, the server may access the data structure from streaming services and clients in order to generate a gaming structure. For example, the server may utilize game streaming sites such as Twitch™ that provide access to videos comprising full playthroughs of games, from start to finish, with real-time commentary from the streamer and their viewers. By applying existing techniques known in the art to analyze the content of such videos, the server may generate a game structure of the gaming application exhibited within the videos. For example, the video may identify game milestones, including unlocked achievements, directly by analyzing game footage. In some embodiments, the server may join live stream sessions to query users about specific details in relation to the gaming application. For example, the server may query “Did you beat the Swamp boss before reaching this level?” In some embodiments, the server may implement chatbots within live streams for said queries. In some embodiments, the server may integrate a feedback loop where the responses from the streamer and viewers to the chatbot's questions are used to refine the game structure analysis. This ensures that the server's understanding of the game structure improves over time, with increased accuracy and depth. Based on the gathered data from various data structures, the server may then generate a gaming structure based on this gathered data.

In some embodiments, the server may implement deep learning models trained on video game content to recognize in-game elements, such as UI elements, specific game scenes, characters, and text on screen. These models can be trained using supervised learning with a dataset comprising labeled video frames from a wide range of games, identifying key milestones like achievements unlocked, level completions, boss fights, and the like. The server may implement optical character recognition techniques (OCR) to extract readable text from the game footage, which can be useful for identifying game levels, player achievements, and other text-based information. The server may also implement scene detection and classification algorithms to segment the streaming video into distinct scenes or segments. Each segment may be classified based on its content to map out the game's structure, including levels, chapters, and significant plot points. Similarly, the server may implement speech recognition techniques to transcribe the streamer's commentary and viewer interactions in real-time. Natural Language Processing (NLP) techniques can then analyze this transcript to extract information related to the game's structure, player decisions, and reactions to specific in-game events.

In some embodiments, the server may compile context enhancement information using a large language model (LLM). The server may gather context information, including player objectives, current location, challenges, status, and the part of a user search query. The server may then generate a text prompt for the LLM. The server generates the text prompt by including the compiled context information. For example, the prompt may be inputted as: “Given the following game context [insert context details], generate an enhanced search query tailored for Google/Reddit/Discord.” The server may then input the generated text prompt into the LLM. The LLM may process the context information and use its understanding of language, search behaviors, and likely the specifics of each platform (Google, Reddit, Discord) to generate an optimized search query. The server receives the enhanced query from the LLM. In some embodiments, the server may transmit a confirmation option to the user to ensure that the enhanced search query is acceptable for searching. Upon a received confirmation, the server then performs a search using the enhanced search query.

In some embodiments, the server may access the data structure via one or more external data sources. In some embodiments, the server may access the data structure via aggregate sources. For example, external data sources may include search engines (e.g., Google), knowledge sharing forums (e.g., Reddit), or voice chat/messaging application (e.g., Discord). Th server may implement APIs to interface with these external data structures. For example, the server may search Google to determine various websites or blogs that mention game structure for a particular gaming application. In another example, the server may use a speech-to-text methodology to transcribe conversations on Discord to determine how players are advancing through the game structure. In some embodiments, the server manages necessary authentication with these external data sources. For example, the server may implement tokens or OAuth where applicable, to access personalized or protected content from external data sources. In some embodiments, the server may collect responses from multiple external data sources to ensure a comprehensive set of data for filtering and summarization.

In some embodiments, the server may perform the disclosed systems and methods for non-linear media that includes e-books. In this example, the e-book may have a multitude of possible paths that the reader can choose that leads to a non-linear path to completion of the book. In this fashion, if the device associated with a user profile wishes to search for a particular topic in more depth, the same disclosed systems and methods may be applied to prevent spoilers from being returned to the device associated with a user profile. In this way, the user profile may engage with the e-book multiple times without certain paths having previously been spoiled.

In some embodiments, the server may perform the disclosed systems and methods for non-linear media that includes 3D VR environments. In this example, the VR environment may have a multitude of possible paths that the VR user can choose to explore. In this fashion, if the VR device associated with a user profile wishes to search for a particular area, the other areas not explored in the VR environment are not spoiled.

In some embodiments, the server may perform the disclosed systems and methods for non-linear media that includes dynamic non-linear video. For example, the non-linear video may be auto-generated (e.g., based on real-time generative artificial intelligence, or pre-loaded renders) based on inputs received from a device associated with a user profile. In this example, the non-linear video may have a multitude of possible generated videos that are dependent on the inputs from the device. In this fashion, if the device associated with a user profile wishes to search for a particular version of the video, the other possibilities of the video are not spoiled.

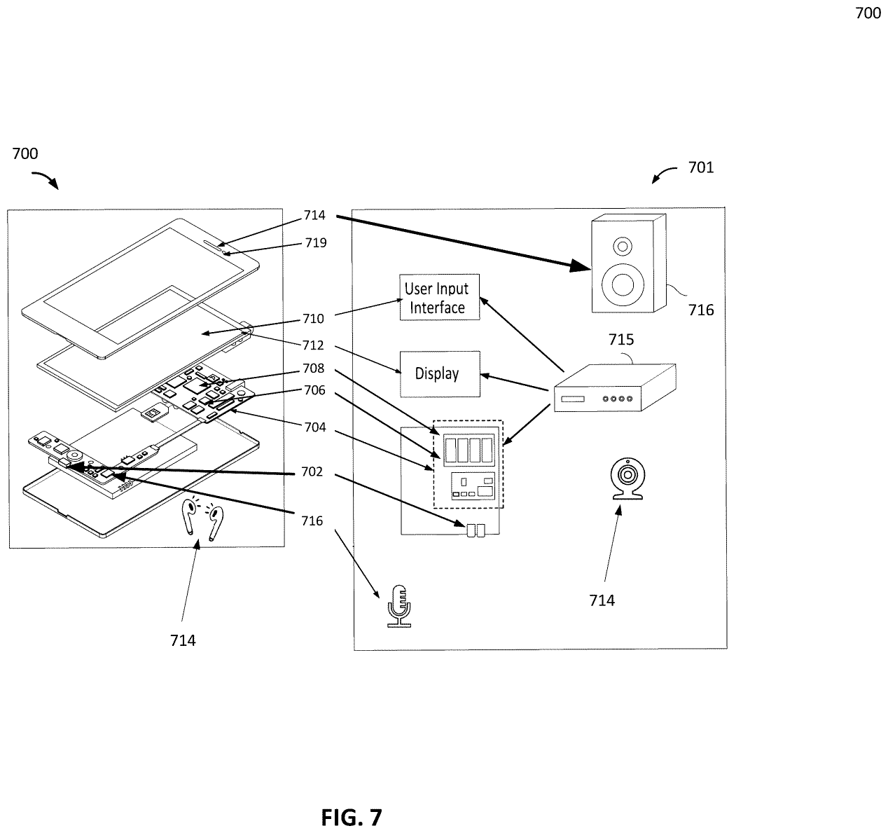

FIGS. 7-8 describe illustrative devices, systems, servers, and related hardware for a media application for processing and executing spoiler prevention for non-linear media. FIG. 7 shows generalized embodiments of illustrative user devices 700 and 701. For example, user equipment device 700 may be a smartphone device, a tablet, smart glasses, a virtual reality or augmented reality device (e.g., AR goggles, AR headset, AR implemented via smartphone, tablet, or computer), or any other suitable device capable of consuming media assets and capable of transmitting and receiving data over a communication network. In another example, user equipment device 701 may be a user television equipment system or device. User television equipment device 701 may include set-top box 715. Set-top box 715 may be communicatively connected to microphone 716, audio output equipment (e.g., speaker or headphones 714), and display 712. In some embodiments, microphone 716 may receive audio corresponding to a voice of a user, e.g., a voice command. In some embodiments, display 712 may be a television display or a computer display. In some embodiments, set-top box 715 may be communicatively connected to user input interface 710. In some embodiments, user input interface 710 may be a remote-control device. Set-top box 715 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment devices are discussed below in connection with FIG. 7. In some embodiments, device 700 may comprise any suitable number of sensors, as well as a GPS module (e.g., in communication with one or more servers and/or cell towers and/or satellites) to ascertain a location of device 700.

Each one of user equipment device 700 and user equipment device 701 may receive content and data via input/output (I/O) path 702. I/O path 702 may provide content (e.g., broadcast programming, on-demand programming, Internet content, content available over a local area network (LAN) or wide area network (WAN), and/or other content) and data to control circuitry 704, which may comprise processing circuitry 706 and storage 708. Control circuitry 704 may be used to send and receive commands, requests, and other suitable data using I/O path 702, which may comprise I/O circuitry. I/O path 702 may connect control circuitry 704 (and specifically processing circuitry 706) to one or more communications paths (described below). I/O functions may be provided by one or more of these communications paths but are shown as a single path in FIG. 7 to avoid overcomplicating the drawing. While set-top box 715 is shown in FIG. 7 for illustration, any suitable computing device having processing circuitry, control circuitry, and storage may be used in accordance with the present disclosure. For example, set-top box 715 may be replaced by, or complemented by, a personal computer (e.g., a notebook, a laptop, a desktop), a smartphone (e.g., device 700), a tablet, a network-based server hosting a user-accessible client device, a non-user-owned device, any other suitable device, or any combination thereof.

Control circuitry 704 may be based on any suitable control circuitry such as processing circuitry 706. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 704 executes instructions for the Media application stored in memory (e.g., storage 708). Specifically, control circuitry 704 may be instructed by the Media application to perform the functions discussed above and below. In some implementations, processing or actions performed by control circuitry 704 may be based on instructions received from the Media application.

In client/server-based embodiments, control circuitry 704 may include communications circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 7, the instructions may be stored in storage 708, and executed by control circuitry 704 of a device 700.

In some embodiments, the media application may be a client/server application where only the client application resides on device 700, and a server application resides on an external server (e.g., server 804 and/or server 816). For example, the media application may be implemented partially as a client application on control circuitry 704 of device 700 and partially on server 804 as a server application running on control circuitry 811. Server 804 may be a part of a local area network with one or more of devices 700 or may be part of a cloud computing environment accessed via the internet. In a cloud computing environment, various types of computing services for performing searches on the internet or informational databases, providing storage (e.g., for a database) or parsing data are provided by a collection of network-accessible computing and storage resources (e.g., server 804), referred to as “the cloud.” Device 700 may be a cloud client that relies on the cloud computing capabilities from server 804 to determine whether processing should be offloaded and facilitate such offloading. When executed by control circuitry 704 or 811, the media application may instruct control circuitry 704 or 811 circuitry to perform processing tasks for the client device and facilitate a media consumption session integrated with social network services. The client application may instruct control circuitry 704 to determine whether processing should be offloaded.

Control circuitry 704 may include communications circuitry suitable for communicating with a server, social network service, a table or database server, or other networks or servers The instructions for carrying out the above-mentioned functionality may be stored on a server (which is described in more detail in connection with FIG. 7). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 7). In addition, communications circuitry may include circuitry that enables peer-to-peer communication of user equipment devices, or communication of user equipment devices in locations remote from each other (described in more detail below).

Memory may be an electronic storage device provided as storage 708 that is part of control circuitry 704. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 708 may be used to store various types of content described herein as well as media application data described above. Nonvolatile memory may also be used (e.g., to launch a boot-up routine and other instructions). Cloud-based storage may be used to supplement storage 708 or instead of storage 708.

Control circuitry 704 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 704 may also include scaler circuitry for upconverting and downconverting content into the preferred output format of user equipment 700. Control circuitry 704 may also include digital-to-analog converter circuitry and analog-to-digital converter circuitry for converting between digital and analog signals. The tuning and encoding circuitry may be used by user equipment device 700, 701 to receive and to display, to play, or to record content. The tuning and encoding circuitry may also be used to receive media consumption data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 708 is provided as a separate device from user equipment device 700, the tuning and encoding circuitry (including multiple tuners) may be associated with storage 708.

Control circuitry 704 may receive instruction from a user by way of user input interface 710. User input interface 710 may be any suitable user interface, such as a remote control, mouse, trackball, keypad, keyboard, touch screen, touchpad, stylus input, joystick, voice recognition interface, or other user input interfaces. Display 712 may be provided as a stand-alone device or integrated with other elements of each one of user equipment device 700 and user equipment device 701. For example, display 712 may be a touchscreen or touch-sensitive display. In such circumstances, user input interface 710 may be integrated with or combined with display 712. In some embodiments, user input interface 710 includes a remote-control device having one or more microphones, buttons, keypads, or any other components configured to receive user input or combinations thereof. For example, user input interface 710 may include a handheld remote-control device having an alphanumeric keypad and option buttons. In a further example, user input interface 710 may include a handheld remote-control device having a microphone and control circuitry configured to receive and identify voice commands and transmit information to set-top box 715.

Audio output equipment 714 may be integrated with or combined with display 712. Display 712 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 712. Audio output equipment 714 may be provided as integrated with other elements of each one of device 700 and equipment 701 or may be stand-alone units. An audio component of videos and other content displayed on display 712 may be played through speakers (or headphones) of audio output equipment 714. In some embodiments, audio may be distributed to a receiver (not shown), which processes and outputs the audio via speakers of audio output equipment 714. In some embodiments, for example, control circuitry 704 is configured to provide audio cues to a user, or other audio feedback to a user, using speakers of audio output equipment 714. There may be a separate microphone 716 or audio output equipment 714 may include a microphone configured to receive audio input such as voice commands or speech. For example, a user may speak letters or words that are received by the microphone and converted to text by control circuitry 704. In a further example, a user may voice commands that are received by a microphone and recognized by control circuitry 704. Camera 718 may be any suitable video camera integrated with the equipment or externally connected. Camera 718 may be a digital camera comprising a charge-coupled device (CCD) and/or a complementary metal-oxide semiconductor (CMOS) image sensor. Camera 718 may be an analog camera that converts to digital images via a video card.

The media application may be implemented using any suitable architecture. For example, it may be a stand-alone application wholly implemented on each one of user equipment device 700 and user equipment device 701. In such an approach, instructions of the application may be stored locally (e.g., in storage 708), and data for use by the application is downloaded on a periodic basis (e.g., from an out-of-band feed, from an Internet resource, or using another suitable approach). Control circuitry 704 may retrieve instructions of the application from storage 708 and process the instructions to provide media consumption and social network interaction functionality and generate any of the displays discussed herein. Based on the processed instructions, control circuitry 704 may determine what action to perform when input is received from user input interface 710. For example, movement of a cursor on a display up/down may be indicated by the processed instructions when user input interface 710 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 704 may allow a user to provide user profile information or may automatically compile user profile information. For example, control circuitry 704 may access and monitor network data, video data, audio data, processing data, participation data from a media application and social network profile. Control circuitry 704 may obtain all or part of other user profiles that are related to a particular user (e.g., via social media networks), and/or obtain information about the user from other sources that control circuitry 704 may access. As a result, a user can be provided with a unified experience across the user's different devices.

In some embodiments, the media application is a client/server-based application. Data for use by a thick or thin client implemented on each one of user equipment device 700 and user equipment device 701 may be retrieved on-demand by issuing requests to a server remote to each one of user equipment device 700 and user equipment device 701. For example, the remote server may store the instructions for the application in a storage device. The remote server may process the stored instructions using circuitry (e.g., control circuitry 704) and generate the displays discussed above and below. The client device may receive the displays generated by the remote server and may display the content of the displays locally on device 700. This way, the processing of the instructions is performed remotely by the server while the resulting displays (e.g., that may include text, a keyboard, or other visuals) are provided locally on device 700. Device 700 may receive inputs from the user via input interface 710 and transmit those inputs to the remote server for processing and generating the corresponding displays. For example, device 700 may transmit a communication to the remote server indicating that an up/down button was selected via input interface 710. The remote server may process instructions in accordance with that input and generate a display of the application corresponding to the input (e.g., a display that moves a cursor up/down). The generated display may then be transmitted to device 700 for presentation to the user.

In some embodiments, the media application may be downloaded and interpreted or otherwise run by an interpreter or virtual machine (run by control circuitry 704). In some embodiments, the media application may be encoded in the ETV Binary Interchange Format (EBIF), received by control circuitry 704 as part of a suitable feed, and interpreted by a user agent running on control circuitry 704. For example, the media application may be an EBIF application. In some embodiments, the media application may be defined by a series of JAVA-based files that are received and run by a local virtual machine or other suitable middleware executed by control circuitry 704. In some of such embodiments (e.g., those employing MPEG-2 or other digital media encoding schemes), the media application may be, for example, encoded and transmitted in an MPEG-2 object carousel with the MPEG audio and video packets of a program.

FIG. 8 is a diagram of an illustrative system 800, in accordance with some embodiments of this disclosure. User equipment devices 807, 808, 809, 810 (e.g., user device; devices or any other suitable devices, or any combination thereof) may be coupled to communication network 806. Communication network 806 may be one or more networks including the Internet, a mobile phone network, mobile voice or data network (e.g., a 5G, 4G, or LTE network, or any other suitable network or any combination thereof), cable network, public switched telephone network, or other types of communication network or combinations of communication networks. Paths (e.g., depicted as arrows connecting the respective devices to the communication network 806) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 8 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 806.

System 800 may comprise media content source 802, one or more servers 804, and one or more social network services. In some embodiments, the media application may be executed at one or more of control circuitry 811 of server 804 (and/or control circuitry of user equipment devices 807, 808, 809, 810.

In some embodiments, server 804 may include control circuitry 811 and storage 814 (e.g., RAM, ROM, Hard Disk, Removable Disk, etc.). Instructions for the media application may be stored in storage 814. In some embodiments, the media application, via control circuitry, may execute functions outlined in FIGS. 1-5. Storage 814 may store one or more databases. Server 804 may also include an input/output path 812. I/O path 812 may provide media consumption data, social networking data, device information, or other data, over a local area network (LAN) or wide area network (WAN), and/or other content and data to control circuitry 811, which may include processing circuitry, and storage 814. Control circuitry 811 may be used to send and receive commands, requests, and other suitable data using I/O path 812, which may comprise I/O circuitry. I/O path 812 may connect control circuitry 811 (and specifically control circuitry) to one or more communications paths. I/O path 812 may comprise I/O circuitry.

Control circuitry 811 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 811 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 811 executes instructions for an emulation system application stored in memory (e.g., the storage 814). Memory may be an electronic storage device provided as storage 814 that is part of control circuitry 811.

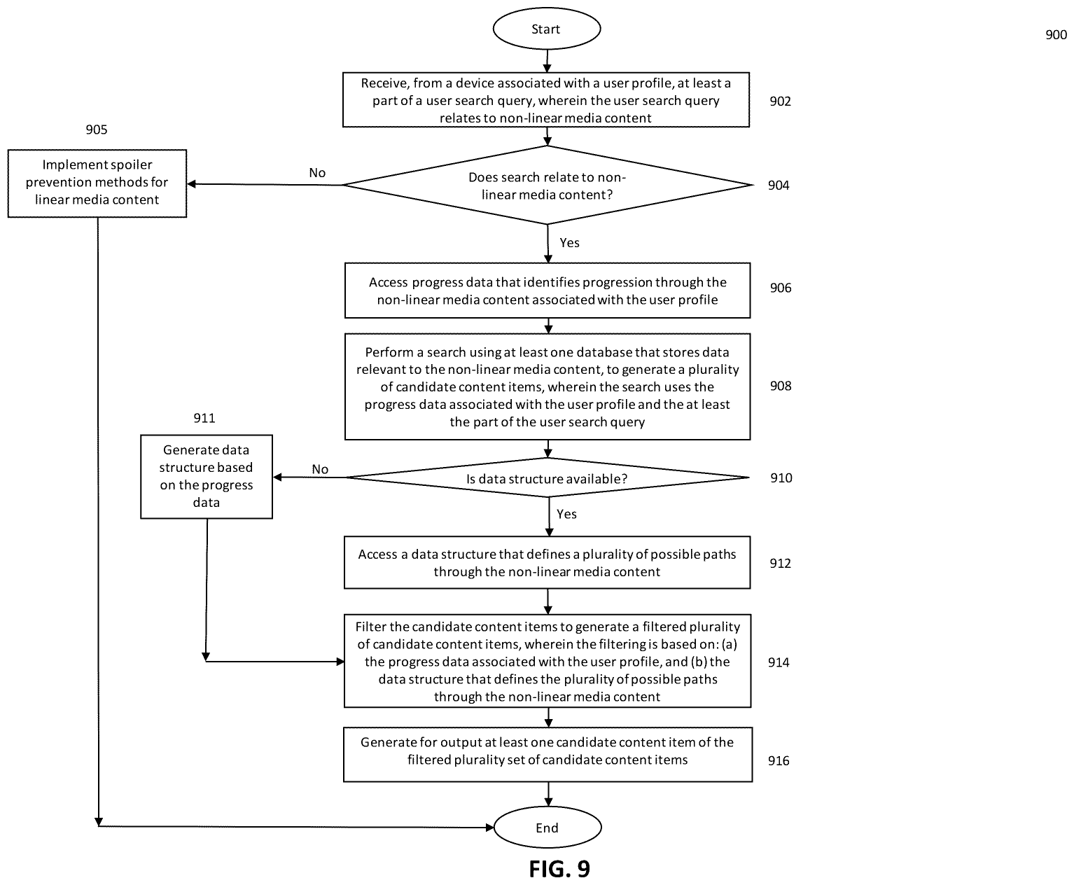

FIG. 9 is a flowchart of a detailed illustrative process for filtering candidate content items to generate for output at least one candidate content item of the filtered plurality set of candidate content items, in accordance with some embodiments of this disclosure. In various embodiments, the individual steps of process 900 may be implemented by one or more components of the devices and systems of FIGS. 1-8. Although the present disclosure may describe certain steps of process 900 (and of other processes described herein) as being implemented by certain components of the devices and systems of FIGS. 1-8, this is for purposes of illustration only, and it should be understood that other components of the devices and systems of FIGS. 1-8 may implement those steps instead.

At 902, the server, via the control circuitry 811, receives from a device associated with a user profile, at least a part of a user search query. In some embodiments, the server receives, via the communication network 809, the part of a user search query from user equipment 807, 808, 809 (via I/O path 812).

At 904, the server, via the control circuitry 811, determines whether the at least the part of the user search query relates to non-linear media content. If, at 904, the server, via control circuitry 811, determines the at least the part of the user search query does not relate to non-linear media content, the process continues to 905. At 905, the server, via control circuitry 811, implements spoiler prevention methods for linear media content. If, at 904, the server, via control circuitry 811, determines the at least the part of the user search query relates to non-linear media content, the process continues to 906.

At 906, the server, via control circuitry 811, accesses progress data that identifies progression through the non-linear media content associated with the user profile. In some embodiments, the server accesses progress data via the I/O path 812. In some embodiments, the server accesses progress data from at least one of user equipment 807, 808, 810, database 805, media content source 802, and storage 814.

At 908, the server, via control circuitry 811, performs a search using at least one database that stores data relevant to the non-linear media content to generate a plurality of candidate content items. The search uses the progress data associated with the user profile and the at least the part of the user search query.

At 910, the server, via control circuitry 811, determines whether the at least one database that stores data relevant to the non-linear media content is available. If, at 910, the server, via control circuitry 811, determines the at least one database that stores data relevant to the non-linear media content is not available, the process continues to 911. At 911, the server, via control circuitry 811, generates a data structure based on the progress data (as shown in FIG. 5 and FIG. 6, for example). The server, via control circuitry 811, may generate the data structure by receiving data from a game client 802. In some embodiments, the server, via control circuitry 811, may generate the data structure by receiving data from one or more of user equipment 807, 808, and 810. If, at 910, the server, via control circuitry 811, determines the at least one database that stores data relevant to the non-linear media content is available, the process continues to 912.

In the present example, at 912, the server, via control circuitry 811, accesses a data structure, from the at least one database that stores data relevant to the non-linear media content, and which data structure defines a plurality of possible paths through the non-linear media content. In some embodiments, the server accesses the data structure via the I/O path 812. In some embodiments, the server accesses the data structure, via the communication network 809, from at least one of user equipment 807, 808, 810, database 805, media content source 802, and storage 814.

At 914, the server, via control circuitry 811, filters the candidate content items to generate a filtered plurality of candidate content items, wherein the filtering is based on: (a) the progress data associated with the user profile, and (b) the data structure that defines the plurality of possible paths through the non-linear media content.

At 916, the server, via control circuitry 811, generates for output at least one candidate content item of the filtered plurality set of candidate content items. In some embodiments, the server generates for output at least one candidate content item via the I/O path 812. In some embodiments, the server generates for output, via the communication network 809, at least one candidate content item to at least one of user equipment 807, 808, 810, and media content source 802. By the server selectively generating for output at least one candidate content item using the process of filtering based on progress data associated with the user profile and the data structure associated with the non-linear media, the process 900 may help to avoid providing a suggested search query and/or a search query result that includes a spoiler (e.g., information that is outside of a scope of the user profile's actual progression through the non-linear media).

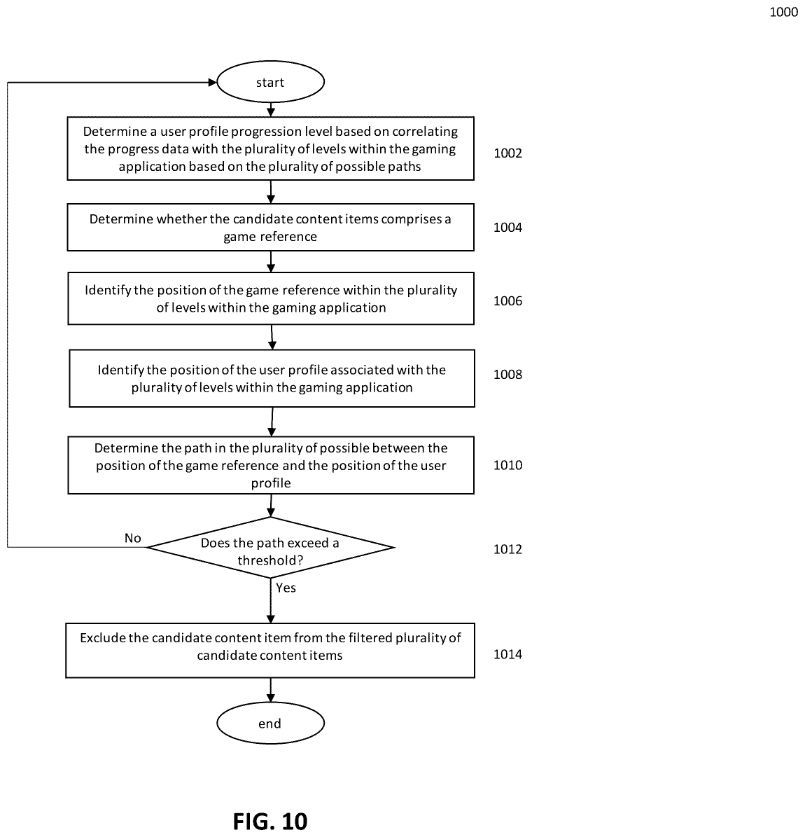

FIG. 10 is a flowchart of a detailed illustrative process 1000 for excluding a candidate content item from the filtered plurality of candidate content items, in accordance with some embodiments of this disclosure. At 1002, the server, via control circuitry 811, determines a user profile progression level based on correlating the progress data with the plurality of levels within the gaming application based on the plurality of possible paths.

At 1004, the server, via control circuitry 811, determines whether the candidate content items comprise a game reference. At 1006, the server, via control circuitry 811, identifies the position of the game reference within the plurality of levels within the gaming application. At 1008, the server, via control circuitry 811, identifies the position of the user profile associated with the plurality of levels within the gaming application.

At 1010, the server, via control circuitry 811, determines the path in the plurality of possible paths between the position of the game reference and the position of the user profile. At 1012, the server, via control circuitry 811, determines whether the determined path exceeds a threshold. If, at 1012, the server, via control circuitry 811, determines the determined path does not exceed the threshold, the process reverts to the start of the process. If, at 1012, the server, via control circuitry 811, determines the determined path exceeds the threshold, the process continues to 1014.

At 1014, the server, via control circuitry 811, excludes the candidate content item from the filtered plurality of candidate content items.

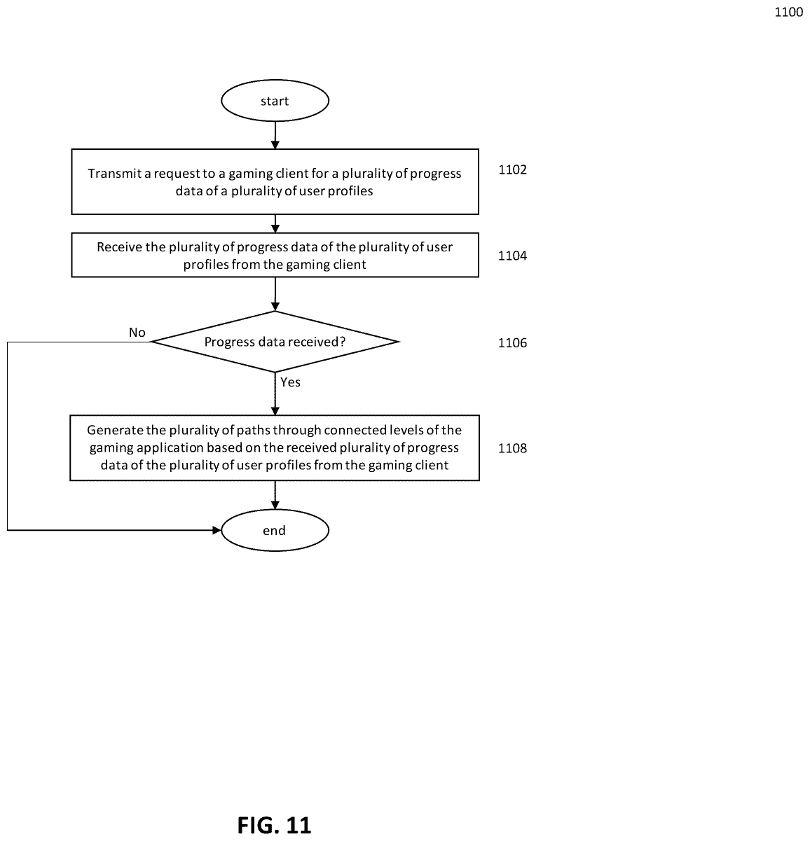

FIG. 11 is a flowchart of a detailed illustrative process for generating a plurality of paths through connected levels of a gaming application, in accordance with some embodiments of this disclosure. At 1102, the server, via control circuitry 811, transmits a request to a gaming client for a plurality of progress data of a plurality of user profiles. In some embodiments, the server transmits the request to the gaming client via the I/O path 812. In some embodiments, the server transmits the request to the gaming client, via the communication network 809, to at least one of media content source 802, user equipment 807, 808, 810, database 805, and storage 814.

At 1104, the server, via control circuitry 811, receives the plurality of progress data of the plurality of user profiles from the gaming client. In some embodiments, the server receives the plurality of progress data via the I/O path 812. In some embodiments, the server receives the plurality of progress data, via the communication network 809, from at least one of media content source 802, user equipment 807, 808, 810, database 805, and storage 814.

At 1106, the server, via control circuitry 811, determines whether the progress data was received. If, at 1106, the server, via control circuitry 811, determines that the progress data was not received, the process continues to the end of the process. If, at 1106, the server, via control circuitry 811, determines that the progress data was received, the process continues to 1108.

At 1108, the server, via control circuitry 811, generates the plurality of paths through connected levels of the gaming application based on the received plurality of progress data of the plurality of user profiles from the gaming client.

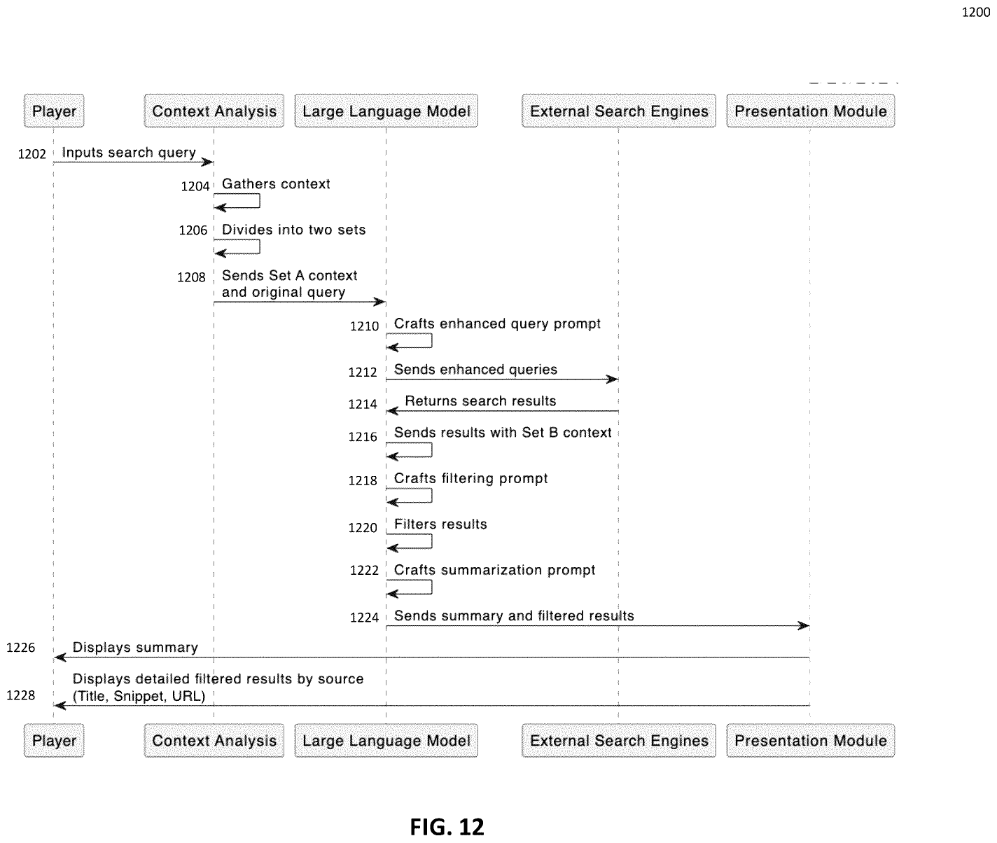

FIG. 12 is a flowchart of a detailed illustrative high-level process 1200 of the disclosed system, in accordance with some embodiments of this disclosure. At 1202, the server, via control circuitry 811, receives an input search query from a device associated with a player in a gaming application. At 1204, the server, via control circuitry 811, gathers context of the search query (e.g., accesses progress data). For example, the server may access that the player is at the swamp level having previously completed the castle level and the search query is “where is the slime potion?”.

At 1206, the server, via control circuitry 811, divides (e.g., filters) the gathered data into two sets. The first set of data is based on progress data (e.g., personalized game information), the second set of data is based on game structure data (e.g., plurality of paths through the gaming application). Continuing with the example, the server may determine the swamp level from the progress data (first set) and determine the game structure (second set) from the gaming client which has the structure as shown in FIG. 1C.

At 1208, the server, via control circuitry 811, transmits the input search query and the context for the query to a large language model (LLM) for analysis. In some embodiments, the LLM may be implement a decoder-only transformer-based architecture, a recurrent neural network variant, or a state space model (e.g., Mamba). In some embodiments, the LLM uses a prompt-based model that may leverage architectures such as GPT-3 models. The LLM may be trained via prompt engineering to alter weights of the tokens, computed by the LLM, that are used to assess relevancy.

At 1210, the server, via control circuitry 811, determines (via the large language model), an enhanced query prompt wherein the enhanced query prompt is devoid of spoilers. For example, the enhanced query prompt may be “having completed the castle and currently playing the swamp level, what is the quickest path to attain the slime potion?”

At 1212, the server, via control circuitry 811, transmits (via the large language model), the enhanced query prompt to external search engines and receives, at 1214, returned search results. At 1216, the server, via control circuitry 811, transmits (via the large language model) the returned search results with the second set of data context. At 1218, the server, via control circuitry 811, generates (via the large language model) the filtering prompt. For example, the filtering prompt may include instructions to exclude any candidate content items in relation to the forest, dungeon, waterfall, and cave levels.

At 1220, the server, via control circuitry 811, filters (via the large language model), the returned search results. At 1222, the server, via control circuitry 811, generates (via the large language model) a summarization prompt and transmits, at 1224, the summarization prompt and filtered results to the generate for output. For example, the output may be a visual map guide on the quickest path to attain the slime potion in the swamp level relative to the current position of the player.

At 1226, the server, via control circuitry 811, outputs the summarization prompt and filtered results to the device associated with the player of the application. At 1128, the server, via control circuitry 811, outputs the detailed filtered results by source (e.g., title, snippet, URL, etc.).

In some embodiments, when the server has generated a plurality of candidate content items, an LLM may be implemented to filter and summarize the generated output. The server may, via the LLM, aggregating the plurality of search results into an aggregate data structure. This aggregate data structure may include titles, URLs, snippets, or abstracts of the information retrieved. The server may then, via the LLM, assesses relevancy and context based on the aggregate data structure. For example, the server may determine the path taken, the player's progress, and similar progress data. The server may also determine the preference for spoiler threshold; the maximum level of spoiler that the player would accept. For example, some players may not want to know anything about future levels, while other players are happy with a teaser of what is to come. The server can determine this based on chat history of the player or other means to determine a calculated spoiler threshold.

The server may then, via the LLM, generate a detailed text prompt includes the aggregated search results and the relevancy and context information as described above. This prompt should instruct the LLM to filter out irrelevant results, spoilers, and information that does not match the player's current capabilities or inventory. The server, via the LLM, may then submit a filtering prompt to the LLM to process the data while excluding only those results that exceed the spoiler threshold for the player.

The server may then, via the LLM, generate an output of the relevant candidate content items that is a concise summary of the initial search query.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, from a device associated with a user profile, at least a part of a user search query, wherein the user search query relates to non-linear media content;
accessing progress data that identifies progression through the non-linear media content associated with the user profile;
performing a search, using at least one database that stores data relevant to the non-linear media content, to generate a plurality of candidate content items, wherein the search uses the progress data associated with the user profile and the at least the part of the user search query;
accessing a data structure that defines a plurality of possible paths through the non-linear media content;
filtering the plurality of candidate content items to generate a filtered set of candidate content items, wherein the filtering is based at least in part on: (a) the progress data associated with the user profile, and (b) the data structure that defines the plurality of possible paths through the non-linear media content; and
generating for output at least one candidate content item of the filtered set of candidate content items.

2. The method of claim 1, wherein the non-linear media content comprises a gaming application; and
wherein the plurality of possible paths comprises a plurality of paths through connected levels of the gaming application.

3. The method of claim 2, wherein the candidate content items comprises a textual item.

4. The method of claim 2, wherein the filtering the plurality of candidate content items comprises:
determining a user profile progression level based on correlating the progress data with a plurality of levels within the gaming application based on the plurality of possible paths; and
wherein the filtered set of the plurality of candidate content items is based on the user profile progression level by excluding one or more candidate content items associated with one or more levels of the gaming application determined to be not traversed based on the correlating.

5. The method of claim 2, wherein the filtering the plurality of candidate content items comprises:
determining a user profile progression level based on correlating the progress data with a plurality of levels within the gaming application based on the plurality of possible paths; and
determining a subset of candidate content items based on the user profile progression level by excluding candidate content items associated with levels of the gaming application determined not to be proximate to the user profile progression level.

6. The method of claim 5, wherein the determining that the candidate content items are associated with levels of the gaming application that are not to be proximate to the user profile progression level comprises:
determining that a particular candidate content item of the candidate content items comprise a game reference;
determining that the game reference is associated with a particular level of the plurality of levels within the gaming application;
identifying an in-game path between the user profile progression level and the particular level; and
determining that length of the in-game path between the user profile progression level and the particular level is smaller than a threshold length.

7. The method of claim 2, wherein the filtering the plurality of candidate content items comprises:
identifying a path through a particular plurality of levels taken by a game character associated with the user profile through the connected levels of the gaming application; and
determining a subset of candidate content items by excluding candidate content items associated with levels of the gaming application determined not to be proximate to the particular plurality of levels included in the path taken by the game character associated with the user profile.

8. The method of claim 2, wherein accessing the data structure that defines the plurality of possible paths through the non-linear media content is a game structure data, wherein:
accessing the data structure further comprises:
transmitting a request to a gaming client for the game structure data related to the gaming application, wherein the game structure data defines at least a set of the plurality of paths through the connected levels of the gaming application; and
receiving the game structure data from the gaming client.

9. The method of claim 2, wherein accessing the data structure further comprises:
transmitting a request to a gaming client for a plurality of progress data of a plurality of user profiles;
receiving the plurality of progress data of the plurality of user profiles from the gaming client; and
generating the plurality of paths through the connected levels of the gaming application based on the received plurality of progress data of the plurality of user profiles from the gaming client.

10. The method of claim 1, wherein upon receiving part of the user search query, the method further comprises:
generating for output one or more autocomplete suggestions based on the received part of the user search query; and
receiving selection of one of the one or more autocomplete suggestions from the device associated with the user profile.

11. A system comprising:
an input/output circuitry configured to:
receive, from a device associated with a user profile, at least a part of a user search query, wherein the user search query relates to non-linear media content;
control circuitry configured to:
access progress data that identifies progression through the non-linear media content associated with the user profile;
perform a search, using at least one database that stores data relevant to the non-linear media content, to generate a plurality of candidate content items, wherein the search uses the progress data associated with the user profile and the at least the part of the user search query;
access a data structure that defines a plurality of possible paths through the non-linear media content;
filter the plurality of candidate content items to generate a filtered set of candidate content items, wherein the filtering is based at least in part on: (a) the progress data associated with the user profile, and (b) the data structure that defines the plurality of possible paths through the non-linear media content; and
wherein the input/output circuitry is further configured to:
generate for output at least one candidate content item of the filtered set of candidate content items.

12. The system of claim 11, wherein the non-linear media content comprises a gaming application; and
wherein the plurality of possible paths comprises a plurality of paths through connected levels of the gaming application.

13. The system of claim 12, wherein the candidate content items comprises a textual item.

14. The system of claim 12, wherein the control circuitry is further configured to filter the plurality of candidate content items by:
determining a user profile progression level based on correlating the progress data with a plurality of levels within the gaming application based on the plurality of possible paths; and
wherein the filtered set of the plurality of candidate content items is based on the user profile progression level by excluding one or more candidate content items associated with one or more levels of the gaming application determined to be not traversed based on the correlating.

15. The system of claim 12, wherein the control circuitry is further configured to filter the plurality of candidate content items by:
determining a user profile progression level based on correlating the progress data with a plurality of levels within the gaming application based on the plurality of possible paths; and
determining a subset of candidate content items based on the user profile progression level by excluding candidate content items associated with levels of the gaming application determined not to be proximate to the user profile progression level.

16. The system of claim 15, wherein the control circuitry is further configured to determine that the candidate content items are associated with levels of the gaming application that are not to be proximate to the user profile progression level by:
determining that a particular candidate content item of the candidate content items comprise a game reference;
determining that the game reference is associated with a particular level of the plurality of levels within the gaming application;
identifying an in-game path between the user profile progression level and the particular level; and
determining that length of the in-game path between the user profile progression level and the particular level is smaller than a threshold length.

17. The system of claim 12, wherein the control circuitry is further configured to filter the plurality of candidate content items by:
identifying a path through a particular plurality of levels taken by a game character associated with the user profile through the connected levels of the gaming application; and
determining a subset of candidate content items by excluding candidate content items associated with levels of the gaming application determined not to be proximate to the particular plurality of levels included in the path taken by the game character associated with the user profile.

18. The system of claim 12, wherein the control circuitry is further configured to access the data structure that defines the plurality of possible paths through the non-linear media content by a game structure data, by:
transmitting a request to a gaming client for the game structure data related to the gaming application, wherein the game structure data defines at least a set of the plurality of paths through the connected levels of the gaming application; and
receiving the game structure data from the gaming client.

19. The system of claim 12, wherein the control circuitry is further configured to access the data structure by:
transmitting a request to a gaming client for a plurality of progress data of a plurality of user profiles;
receiving the plurality of progress data of the plurality of user profiles from the gaming client; and
generating the plurality of paths through the connected levels of the gaming application based on the received plurality of progress data of the plurality of user profiles from the gaming client.

20. The system of claim 11, wherein the control circuitry is further configured to receive part of the user search query by:
generating for output one or more autocomplete suggestions based on the received part of the user search query; and
receiving selection of one of the one or more autocomplete suggestions from the device associated with the user profile.
